(19) United States
(12) Patent Application Publication
(10) Pub. No.: US 2009/0182581 A1
(43) Pub. Date: Jul. 16, 2009

(54) DEVICE AND METHOD FOR PROMPTING BEHAVIORAL CHANGE

(75) Inventors: Ken UENO, Tachikawa-shi (JP); Ryohei ORIHARA, Tokyo (JP)

Correspondence Address: Charles N.J. Ruggiero, Esq.;Ohlandt, Greeley, Ruggiero & Perle, L.L.P., One Landmark, Square, 10th Floor, Stamford, CT, 06901-2682, US

(73) Assignee: KABUSHIKI KAISHA TOSHIBA

(21) Appl. No.: 12/343,595

(22) Filed: Dec. 24, 2008

(30) Foreign Application Priority Data
Dec. 27, 2007 (JP) 2007-338240

(51) Int. Cl. G06Q 50/00; G06Q 99/00; G06F 17/10

(52) U.S. Cl. 705/3; 705/2; 705/10; 703/2

(57) ABSTRACT

A device for prompting behavioral changes generates a probability classification model in consideration of a probability dependence relation among nodes equivalent to each item (attribute) of health examination and doctor's question result data. The device tentatively changes an attribute value of each node of the classification model in an improvement direction, checks changes in classification class node upon tentatively changing, and generates higher-ranking N-pieces of improved plans as plan candidates in descending order of improvements of probabilities of the classification class nodes from the least improvement. The device generates an improved plan portfolio by listing the plan candidates in descending order of easiness of improvements. In response to changes in personal preference and restriction data, the device executes again the generation of the improved plan portfolio, and generates to present an improved plan portfolio after changing.

### CROSS-REFERENCE TO RELATED APPLICATIONS

This application is based upon and claims the benefit of priority from prior Japanese Patent Application No. 2007-338240, filed Dec. 27, 2007, the entire contents of which are incorporated herein by reference.

### BACKGROUND OF THE INVENTION

1. Field of the Invention

The present invention relates to a device and a method for prompting behavioral changes which provide an improved behavior portfolio to an object person so as to prompt, for example, a behavioral change for improving health conditions.

2. Description of the Related Art

Many people cope with improvements of physical conditions by using health examination results as triggers. Because of such a need, based on the health examination results or response results for question sheets, many proposals for systems of promoting plans for improvements of physical conditions by fitting to personal conditions have been produced.

To continuously advance the improvements of the physical conditions, even if the personal conditions varying from hour to hour may be reflected to the systems, and even if each person's living condition is changed, it is necessary for appropriate physical condition improvement plans to be appropriately provided in response to the varying from hour to hour. To actively continue the improvements of the physical conditions, it is considered to be that enhancing motivations is important by taking in desires, restriction (e.g., restriction which is hardly to stop drinking), and accomplishment degrees of the object persons themselves.

In this cases in which correspondence functions for their own desires and restriction are introduced into the systems, it is necessary to finely adjust behavior plans (e.g., setting liver resting days and slightly increasing amounts of exercises only on that days) which take dependence relations of each constituent element of the behavior plans into account.

The existing technique poses a problem such that it may only retrieve the existing plan by fitting the existing plan to the personal physical condition, or it may only take out a part of the plan to correct it.

For instance, while JP-A 2006-293612 (KOKAI) has described a device for making an improvement of one's health plan which adds a restriction condition for each user and selectively provides information in a manner fitting to the user's situation; the technique does not generate an appropriate combination of programs (an improved plan) from information varying dynamically.

While a health information display system which can calculate a health level by using a personal preference and correct an aim has been described in JP-A 2006-065752 (KOKAI), the technique described therein does not create the aforementioned improved plan.

While a health information management system which is useful in health examination for an enterprise and a school has been described in JP-A 2003-085290 (KOKAI), the technique described therein does not put emphasis on the improved plan and also does not create the foregoing improved plan.

### BRIEF SUMMARY OF THE INVENTION

According to an aspect of the invention, there is provided a device for prompting behavioral changes, comprising: a data input unit which inputs first health examination and doctor's question result data with respect to an individual being an object person, and second health examination and doctor's question result data with respect to a plurality of persons other than the object person, the first and second health examination and doctor's question result data including items having attribute values; a personal preference and restriction input unit which inputs personal preference and restriction data showing personal preferences and restriction of the individual being an object person; a filter unit which applies filtering as regards the first and second health examination and doctor's question result data which are input from the data input unit so as to fulfill the personal preference and restriction data obtained from the personal preference and restriction input unit, and remains only health examination and doctor's question result data of persons with the same or close conditions of the object person; a probability model generation unit which uses the health examination and doctor's question result data filtered by the filter unit and generates a probability classification model in consideration of probability dependence relations among nodes equivalent to items of the health examination and doctor's question result data, the model including a classification class node; a plan candidate generation unit which tentatively changes at least one of the attribute values of the nodes of the probability classification model in an improving direction, checks changes in the classification class node upon performing the tentative changes, and generates high-raking N-pieces of improved plans, as plan candidates, in descending order of improvements of probabilities of the classification class nodes through the least improvement; an improved plan portfolio generation unit which generates an improved plan portfolio by listing the plan candidates in descending order of easiness of improvements; an improved plan portfolio change unit which executes again at least any one of the filtering, the generation of the probability classification model, the generation of the plan candidates and the generation of the improved plan portfolio in response to changes in the first and second health examination and doctor's question result data or the personal preference and restriction data, and generates an improved plan portfolio after changing; and a result display unit which displays the improved plan portfolio after changing.

### BRIEF DESCRIPTION OF THE SEVERAL VIEWS OF THE DRAWING

FIG. 1 is an exemplary view depicting a system of an embodiment;

FIG. 2 is an exemplary block diagram depicting a device for prompting behavioral changes of the embodiment;

FIG. 3 is an exemplary view depicting an example of health examination and doctor's question result data;

FIGS. 4A to 4D are exemplary views depicting an example of correspondence among questions and attributes (values) and a preference and restriction questionnaire;

FIGS. 5A to 5E are exemplary views for explaining a filtering operation;

FIG. 6 is another exemplary view for explaining a filtering operation;

FIG. 7 is an exemplary view depicting a concrete example of the health examination and doctor's question result data;

FIG. 8 is an exemplary view depicting a result of narrowing of the concrete example of the health examination and doctor's question result data;

FIG. 9 is an exemplary view for explaining a method by Friedman, et al.;

FIGS. 10A to 10D are another exemplary views for explaining a method by Friedman, et al.;

FIG. 11 is an exemplary view for explaining a method by Keogh, et al.;

FIG. 12 is another exemplary view for explaining a method by Keogh, et al.;

FIG. 13 is an exemplary flowchart depicting a creation procedure of a probability classification model of the embodiment;

FIG. 14 is an exemplary view depicting an example of the probability classification model created in accordance with the procedure shown in FIG. 13;

FIG. 15 is an exemplary view depicting an example of simulation;

FIG. 16 is an exemplary view depicting an example of a generated improved plan portfolio;

FIG. 17 is an exemplary view depicting an example of a check table of a degree of attainment of the improved plan portfolio;

FIG. 18 is an exemplary view depicting an example of a result graph of the degree of the attainment of the improved plan portfolio;

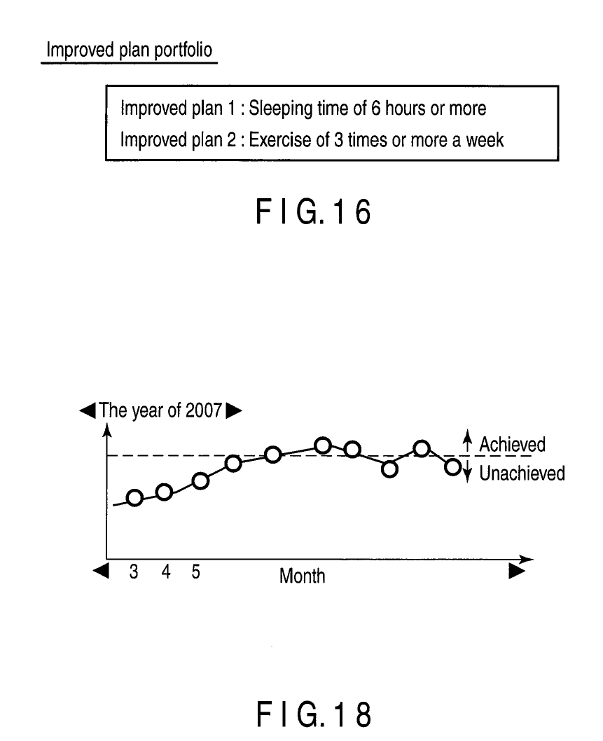

FIG. 19 is an exemplary view for explaining a case in which preferences and restriction have been changed;

FIG. 20 is an exemplary view depicting an example of a re-learning result of the classification model;

FIG. 21 is an exemplary view depicting an example of a change result of the portfolio;

FIG. 22 is an exemplary flowchart depicting a series of processing procedures to be executed by the device for prompting the behavioral changes of the embodiment; and

FIG. 23 is an exemplary view depicting an example of setting information.

### DETAILED DESCRIPTION OF THE INVENTION

An embodiment of the invention is related to an example of a system, which continuously advances a physical condition improvement so as to provide a physical condition improvement plan corresponding to a variation of a living status as needed, even if the living status varies by reflecting a personal state varying hour to hour. To enable an object person such as an employee that is a user of the system to actively continue the improvement of its physical condition, it is important to maintain and enhance the motivation of the object person by taking not only desires or restriction of the object person himself or herself (e.g., restriction such that [it is hardly stop drinking]) but also a degree of attainment for the physical condition improvement. In a system which is made in consideration of changes in desire, restriction and preference of the object person himself or herself, it is necessary to finely adjust an behavior plan which takes dependence on relations of mutual constituent elements of the behavior plan into account (e.g., [setting liver resting days, and slightly increasing an amount of exercise only on the days]).

The device for prompting behavioral changes of this embodiment is the system which takes in the desire and restriction of the object person himself or herself, and further takes a change in preference and a degree of attainment into account. The system analyzes results of health examination of other persons in the organization, calculates to utilize past possibilities of successes and failures, and creates to present a behavioral change plan which has been made in consideration of depending relations of mutual constituent elements of the behavior plan. Thereby, it makes possible to prompt continuous behavioral changes while appropriately correcting the behavioral change plan.

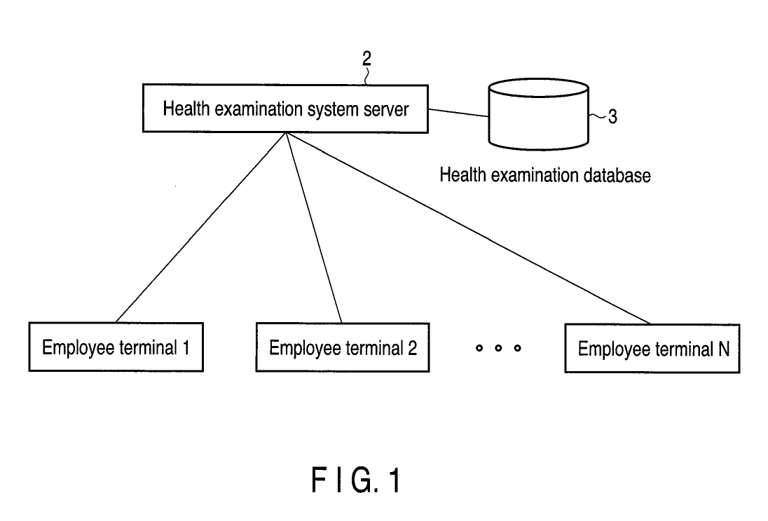

FIG. 1 shows a system of the embodiment. The system is schematically composed of a plurality of employee terminals 1-N, and a health examination system server 2 providing health examination information for each user of the terminals 1-N. An examination database 3 is connected to the system server 2. The system server 2 builds in the device for prompting the behavioral change of the embodiment.

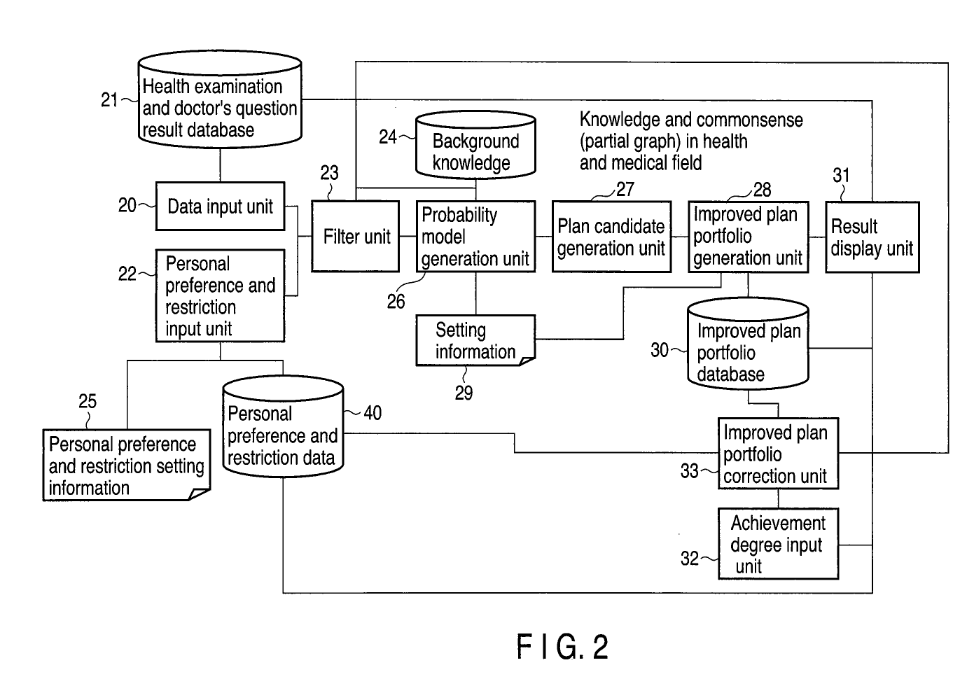

FIG. 2 shows a block diagram depicting the device for prompting the behavioral changes.

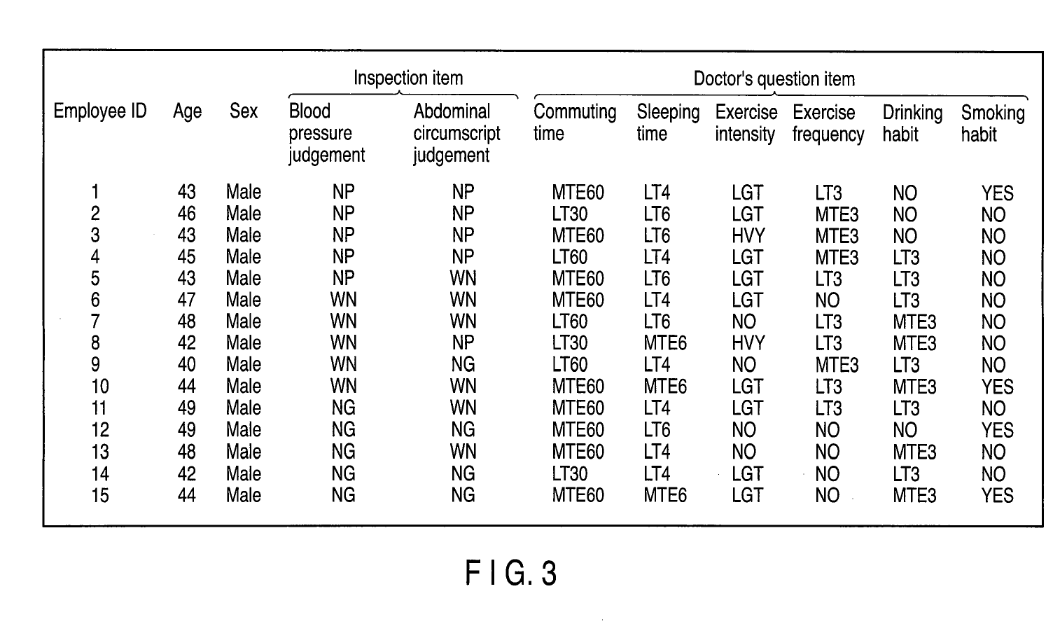

A data input unit 20 inputs health examination data consisting of a plurality items of health examination and doctor's question result data (of organizations) and health examination and doctor's question result data (of users) by means of a health examination and doctor's question data result database 21. The health examination and doctor's question result data is, for example, table data in which personal information, inspection item and doctor's question item data for each of a plurality of employee IDs are integrated, as is shown in FIG. 3. The table may be formed in a state in which the foregoing data is normalized to be stored on a database management system (DBMS), and such an integral table may be created by using a general Structured Query Language (SQL).

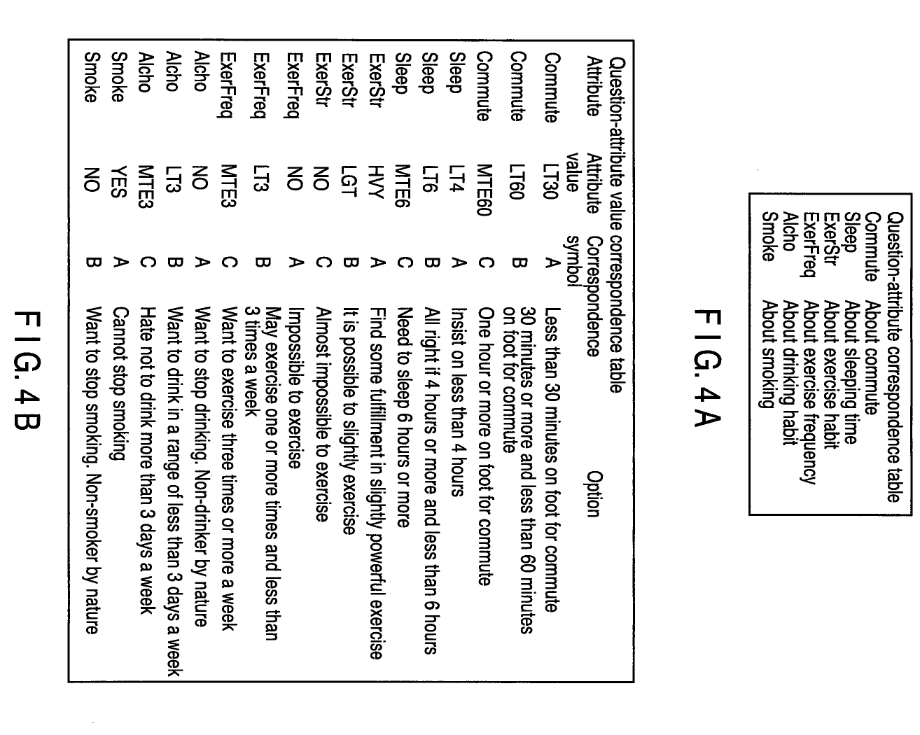

A personal preference and restriction input unit 22 takes in personal preference data (desire, restriction). The personal preference data (desire, restriction) is composed of, for example, personal preference acquisition setting information 25 for taking in user's preferences shown in FIGS. 4 A, 4B and 4C, and personal preference and restriction data 40 shown on a right side of FIG. 4D. The input unit 22 generates to display, for example, a questionnaire 41 shown in FIG. 4D, and takes in the personal preference and restriction data 40 which has been input by a user in accordance with the question items. Wherein, an example in which the employee ID is set as five (ID=5). In this case, the device generates an improving program for behavioral changes of the employee of a current analysis object person's ID is set as five (ID=5). The employee ID may be directly specified by inputting through a keyboard and a mouse by a medical staff, and, for example, the employee's ID may be set into an XML file as shown in FIG. 4C by clicking to select a part of a row corresponding to the ID on the health examination data table of FIG. 3. Individually treating the setting data such as an XML file defining question items of content, options, and question order enables efficiently and flexibly rewriting the items of content of the questionnaire.

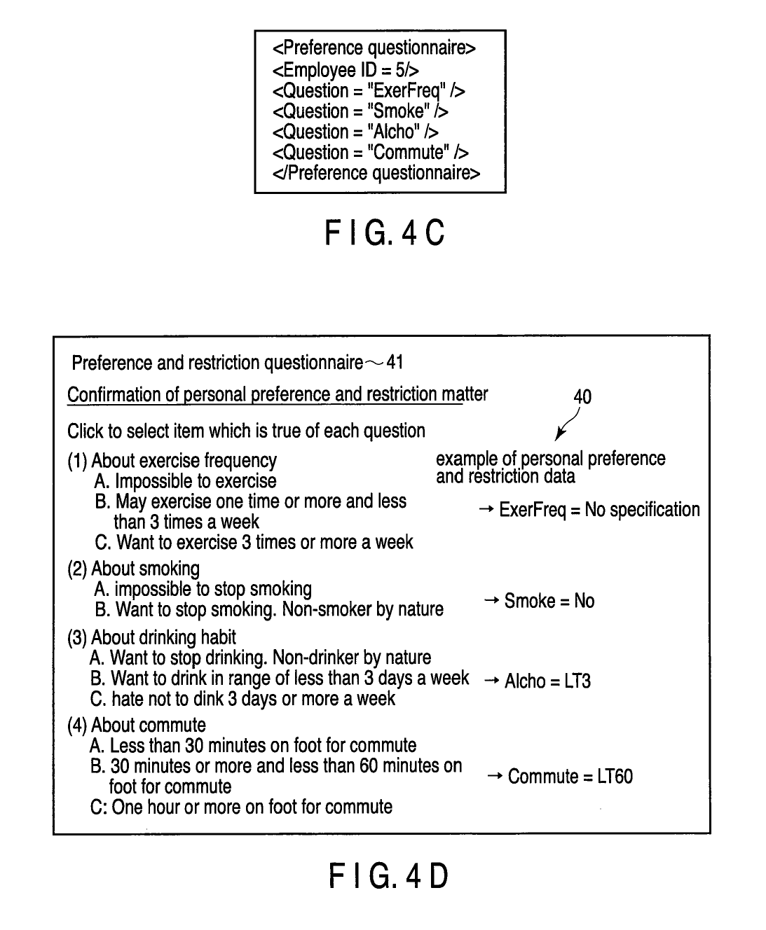

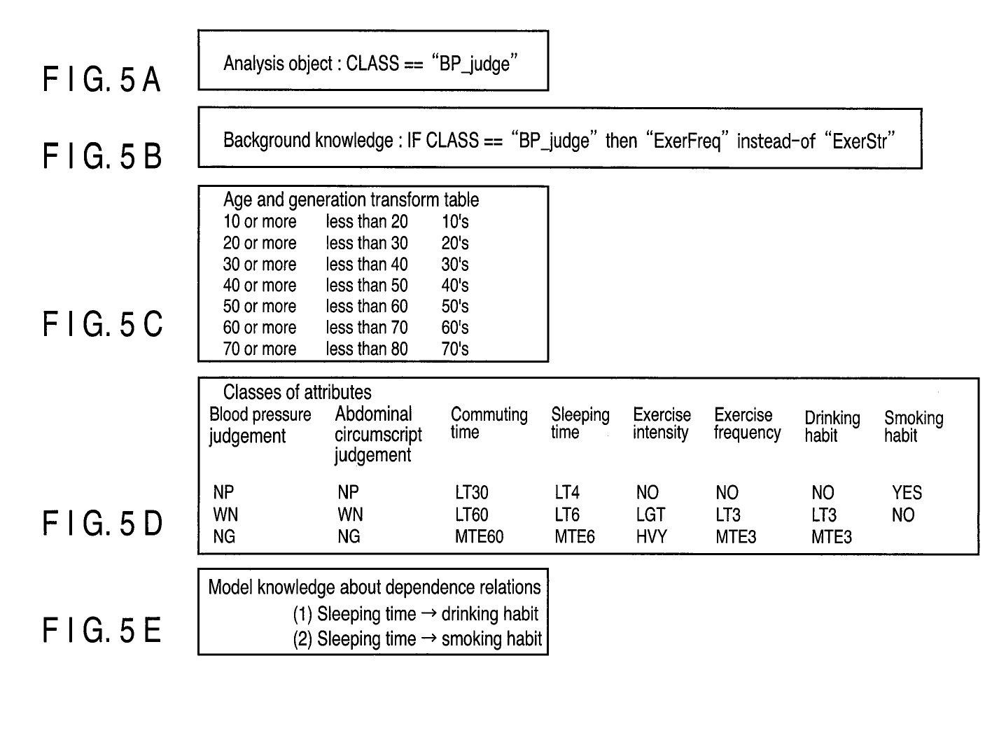

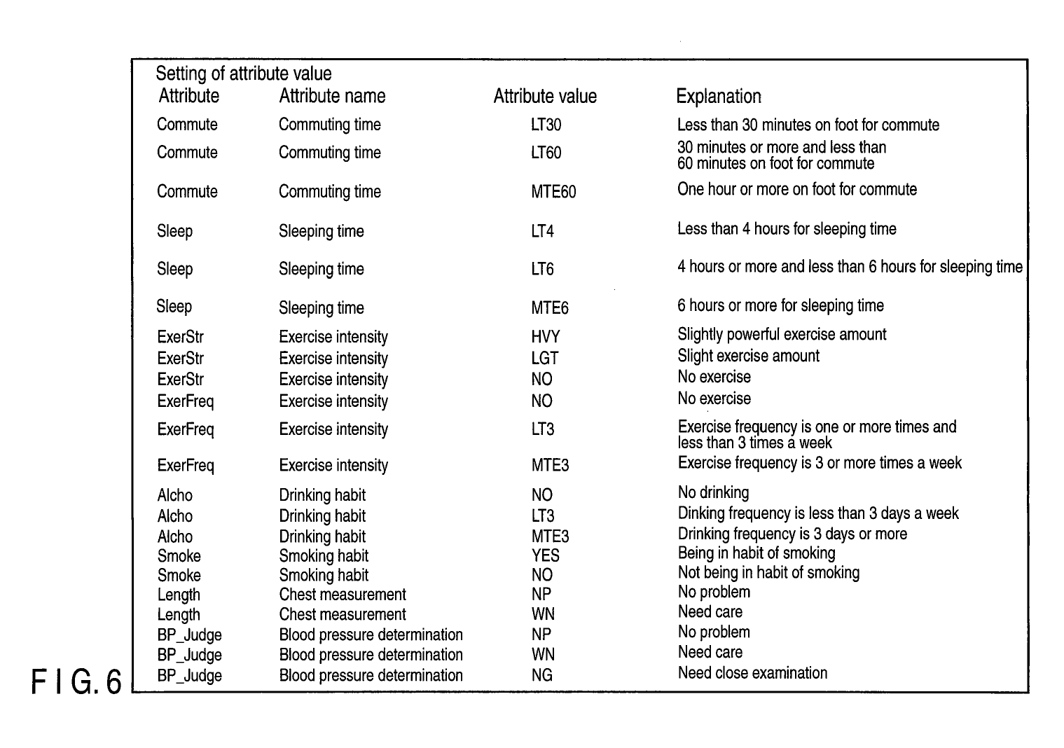

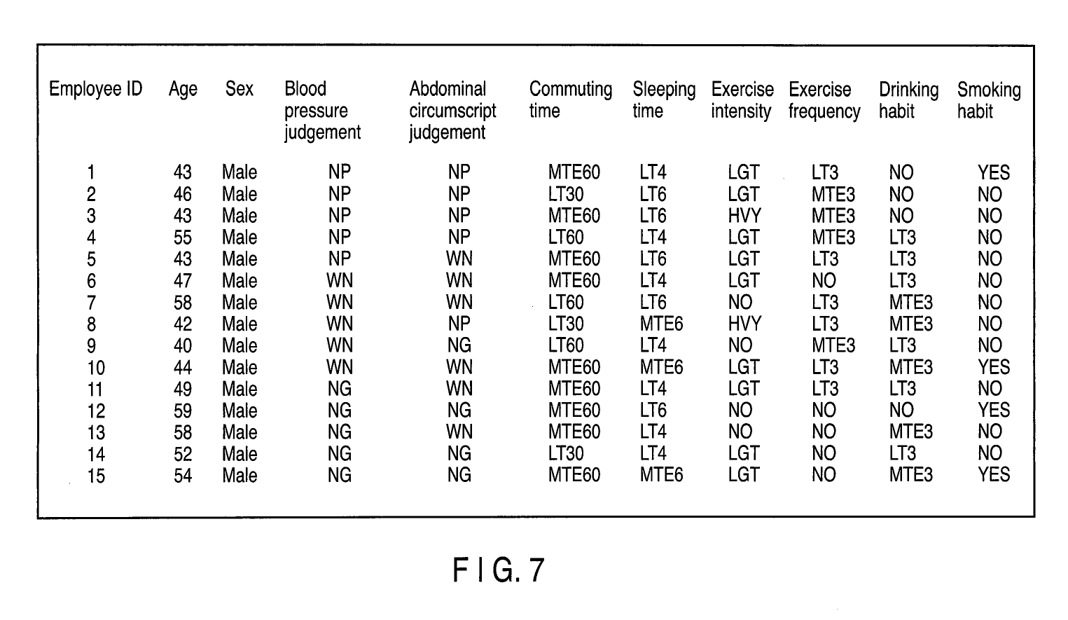

As regards the health examination and doctor's question result data acquired from the data input unit 20, a filter unit 23 fulfils the personal preference and restriction data 40 and background knowledge 24 acquired by the personal preference and restriction input unit 22, and filters the health examination and doctor's question result data so as to remain only the result data of a person who is in a state which is similar or close to a state of an object person during current processing. Wherein, the filtering operation optimally uses, for example, medical knowledge of an analysis object specification as is shown in FIG. 5A, a narrowing specification (background knowledge) of analysis items as is shown in FIG. 5B, age and generation transformation specifications as is shown in FIG. 5C, attribute value setting information as shown in FIG. 5D, and setting (detailed information) of attribute values as is shown in FIG. 6. As a result, the filter unit 23 narrows health examination and doctor's question result data shown in FIG. 7 in a manner as is shown in FIG. 8. According to FIG. 4B, a current analysis object person is the employee with the ID 5. Therefore, to obtain health examination and doctor's question result data shown in FIG. 8 by filtering the result data of FIG. 7, the filter unit 23 firstly referees to the data of the employee with the ID 5, and narrows only data of other employees of which the ages and generations coincide with one another. For instance, according to the medical knowledge data shown in FIG. 5C, if the age is 43-year-old, since the data may be transformed as 40<43-year-old<=50, if the object person is in 40s, the data may be easily calculated from the age. Here, while the generations and sexes of the object persons coincide with all pieces of health examination data, the health examination and doctor's question result data shown in FIG. 8 is output by filtering by the use of the medical knowledge from FIG. 5A to FIG. 5D.

A probability model generation unit 26 uses the health examination and doctor's question result data narrowed by the filter unit 23, and generates a probability classification model which has made in consideration of probability depending relations among the respective items (attributes) of the result data. In the embodiment, while the way of generation of the probability classification model will be described later, at first, a method by Friedman et al., and a method by Keogh et al., will be each described.

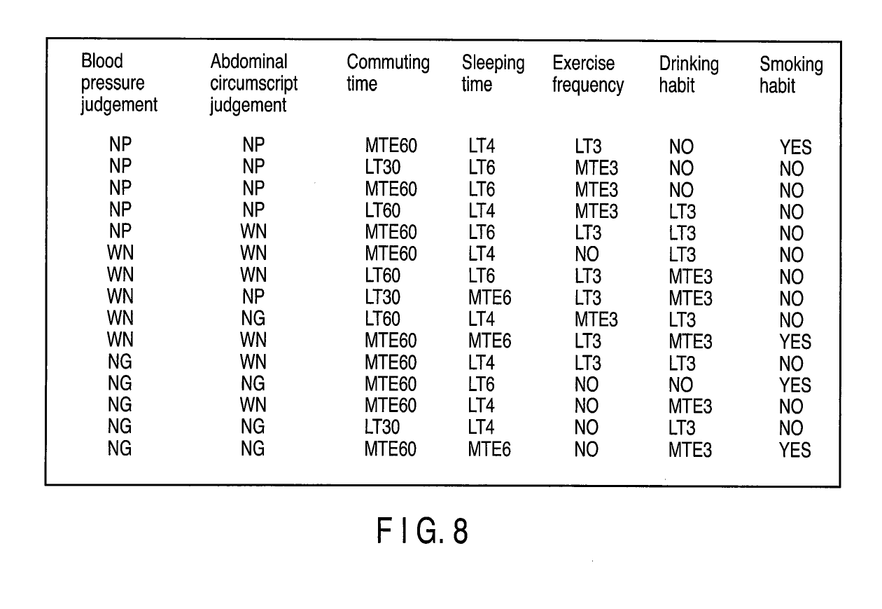

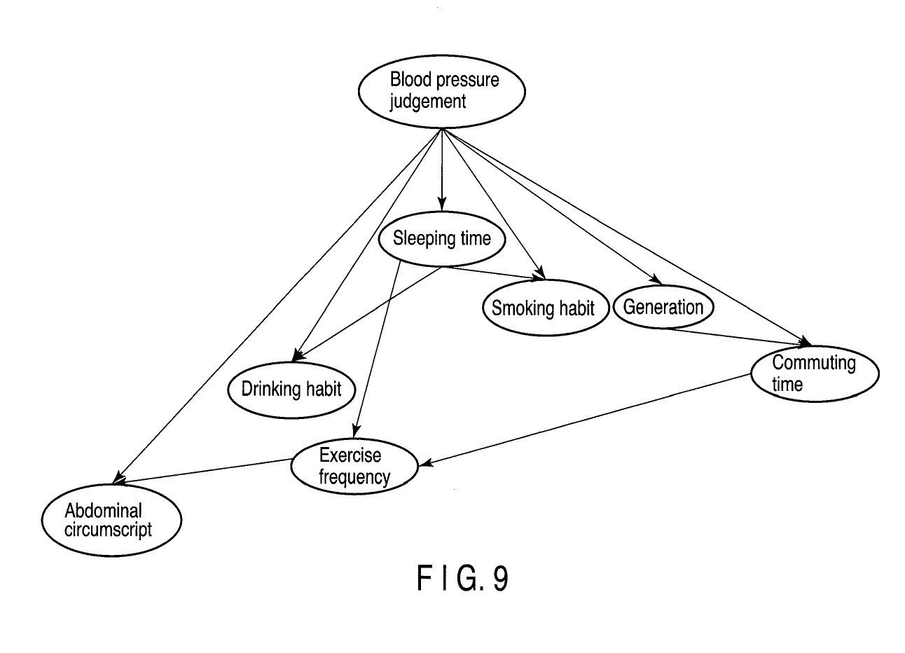

FIGS. 9 and 10 each show examples of cases in which the probability classification models are generated by using the Method by Friedman et al. (a reference document [1] mentioned below). The method by Friedman et al. is a construction method of a tree Augmented Bayesian Network (TAN) using a mutual information quantity with conditions based on a distribution. The method is described as follows:

(1) Calculate a degree of influence I (Xi, Xj|C) on each attribute pair that is i≠j

(2) Construct a perfectly non-directed graph with attributes X1, X2, . . . , Xn as peaks, and put the degree of influence I (Xi, Xj|C) on a side from Xi to Xj

(3) Construct a maximum Weighting Spanning Tree

(4) Select a route variation to transform a non-directed tree to a directed tree, and set all arrow marks output from the route in directions of outward-looking

(5) Add a peak labeled in a Class C, and construct the TN model by adding arcs from C toward Xj

(6) Terminate the construction method when completing additions of arcs to all attribute nodes.

As regards the foregoing degree of influence I, results of probability calculations as shown in FIGS. 10A-10D are used hereinafter.

As shown in FIG. 10A, it is assumed that a probability P (BP_judge [blood pressure judge]=NP) in which “BP_judge” is “NP”, a probability P (BP_judge=WN) in which “BP_judge” is “WN”, and a probability P (BP_judge=NG) in which “BP_judge” is “NG” are 0.333, 0.333, and 0.333, respectively.

As shown in FIG. 10B, under a condition that “BP_judge (blood pressure judge)” is “NP (no problem), a probability that “Sleep (sleeping time)” is “LTE 4 (four hours or less)” is 0.4375, a probability that “Sleep (sleeping time)” is “LTE 6 (four hours or more and six hours or less) is 0.625, and a probability that “Sleep (sleeping time)” is “MT 6 (six hours or more) is 0.0625.

Under the condition that “BP_judge (blood pressure judge)” is “WN (need warning)”, a probability that “Sleep (sleeping time)” is “LTE 4 (four hours or less)” is 0.4375, a probability that “Sleep (sleeping time)” is “LTE 6 (four hours or more and six hours or less) is 0.25, and a probability that “Sleep (sleeping time)” is “MT 6 (six hours or more) is 0.4375.

Under the condition that “BP_judge (blood pressure judge)” is “NG (need close examination), a probability that “Sleep (sleeping time)” is “LTE 4 (four hours or less)” is 0.625, a probability that “Sleep (sleeping time)” is “LTE 6 (four hours or more and six hours or less) is 0.25, and a probability that “Sleep (sleeping time)” is “MT 6 (six hours or more) is 0.25.

As shown in FIG. 10C, under the condition that “BP_judge (blood pressure judge)” is “NP (no problem)”, a probability that “Alcho (drinking habit)” is “No (not drinking)” is 0.625, a probability that “Alcho (drinking habit)” is “LTE 3 (less than three days) is 0.4375, and a probability that “Alcho (drinking habit)” is “MT 3 (three days or more) is 0.625.

Under the condition that “BP_judge is “WN”, a probability that “Alcho (drinking habit)” is “No (not drinking)” is 0.625, a probability that “Alcho (drinking habit)” is “LTE 3 (less than three days) is 0.4375, and a probability that “Alcho (drinking habit)” is “MT 3 (three days or more) is 0.625.

Under the condition that “BP_judge is “NG”, a probability that “Alcho (drinking habit)” is “No (not drinking)” is 0.25, a probability that “Alcho (drinking habit)” is “LTE 3 (less than three days) is 0.4375, and a probability that “Alcho (drinking habit)” is “MT 3 three days or more) is 0.4375.

As shown in FIG. 10D, on condition of each attribute value of “BP_judge”, a probability P “Sleep, Alcho|BP_judge) that each attribute value of “Sleep” and each attribute value “Alcho” occur at the same time is obtained.

A degree of influence from “Sleep (sleeping time)” to “Alcho (drinking habit)” is calculated by obtaining the foregoing degree of influence I (Sleep Alcho|BP_judge) from the probability calculated in such those manners. As regards the concrete calculation method is expressed, for instance, by the following Equation (1)

$${I}_{P} ( X ; Y \vert C ) = {\sum }_{x , y , c} P ( x , y , c ) log \frac{P ( x , y \vert c )}{P ( x \vert c ) P ( y \vert c )} . \qquad ( 1 )$$

Where, X represents an attribute at a certain node, and Y represents an attribute other than X. C represents a class attribute. “x” represents vector composed of all attribute values which can be given to the attribute X, y similarly represents a vector composed of all attribute values which can be given to the attribute Y, and a c similarly represents a vector composed of all attribute values which can be given to the class attribute C. In this example, a formula C=BP_judge is satisfied, and a formula c=<NO, WN, NG> is satisfied. An arbitrary attribute, and an arbitrary other than X are substituted for X and Y, respectively.

The degree of influence I is obtained for each attribute pair on the basis of Equation (1), and a TAN structure is generated by re-arranging each degree of influence I in descending order. For instance, as shown in FIG. 9, the degrees of influences Is between items (attributes), such as from “sleep hour” to “smoking habit”, from “commuting time” to “exercise frequency”, from “exercise frequency” to “abdominal circumscript” are obtained, respectively. In this way, likelihood showing dependence relations between items (attributes) are calculated.

For instance, the degree of influence from “Sleeping time” to “drinking habit”, namely the degree of influence I may be calculated as follows by suing the foregoing Equation (1).

$$\begin{matrix}I ( \begin{matrix}Sleep , \\ Alcho \vert BP\_Judge\end{matrix} ) = P ( \begin{matrix}Sleep = LTE 4 , Alcho = LTE 3 , \\ BP\_Judge = NP\end{matrix} ) \times \\ log \frac{P ( \begin{matrix}Sleep = LTE 4 , \\ Alcho = LTE 3 \vert BP\_Judge = NP\end{matrix} )}{\begin{matrix}P ( Sleep = LTE 4 \vert BP\_Judge = NP ) \times \\ P ( Alcho = LTE 3 \vert BP\_Judge = NP )\end{matrix}} + \\ P ( \begin{matrix}Sleep = LTE 6 , \\ Alcho = NO , BP\_Judge = NP\end{matrix} ) \times \\ log \frac{P ( \begin{matrix}Sleep = LTE 6 , \\ Alcho = NO \vert BP\_Judge = NP\end{matrix} )}{\begin{matrix}P ( Sleep = LTE 6 \vert BP\_Judge = NP ) \times \\ P ( Alcho = NO \vert BP\_Judge = NP )\end{matrix}} \\ … \\ = 0.064385689774724 + 0.60801237 … \\ \approx 1.96\end{matrix} \qquad ( 2 )$$

Where, P (sleep=LTE4, Alcho=NO|BP_judge=NP)=P (Sleep=LTE4, Alcho=NO|BP_judge=NP)/P (BP_judge=NP)=0.2.

P (sleep=LTE4, Alcho=LET3|BP_judge=NP)=P (Sleep=LTE4, Alcho=LTE3, BP_judge=NP)/P (BP_judge=NP)=0.2, and as regards other values, similarly calculating results in a result as shown in FIG. 10D.

After completing the above calculation, as mentioned below, by mutually comparing degrees of influences Is of candidate nodes obtained in this way, a high degree of influence is adopted as a master node for each node. As background knowledge, if there is any candidate master node which is a direction of influence, namely a direction of an arrow is always decided, as shown in FIGS. 5-6, arcs are drawn. For instance, if the following expression “sleeping time”→“drinking habit” is shown, the arc is always added in this direction.

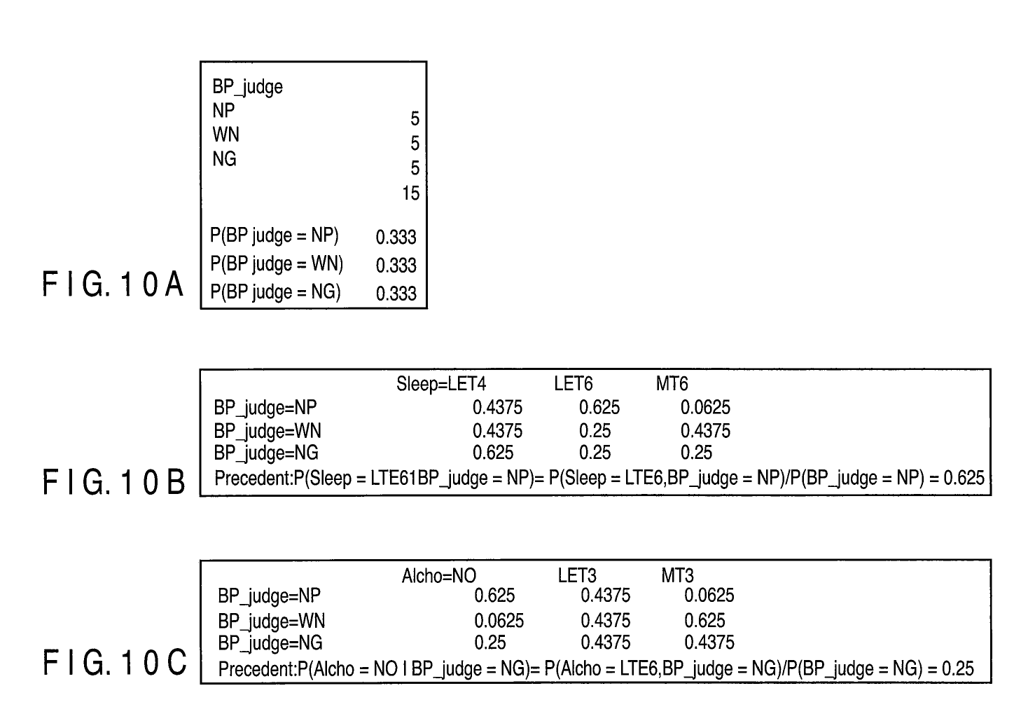

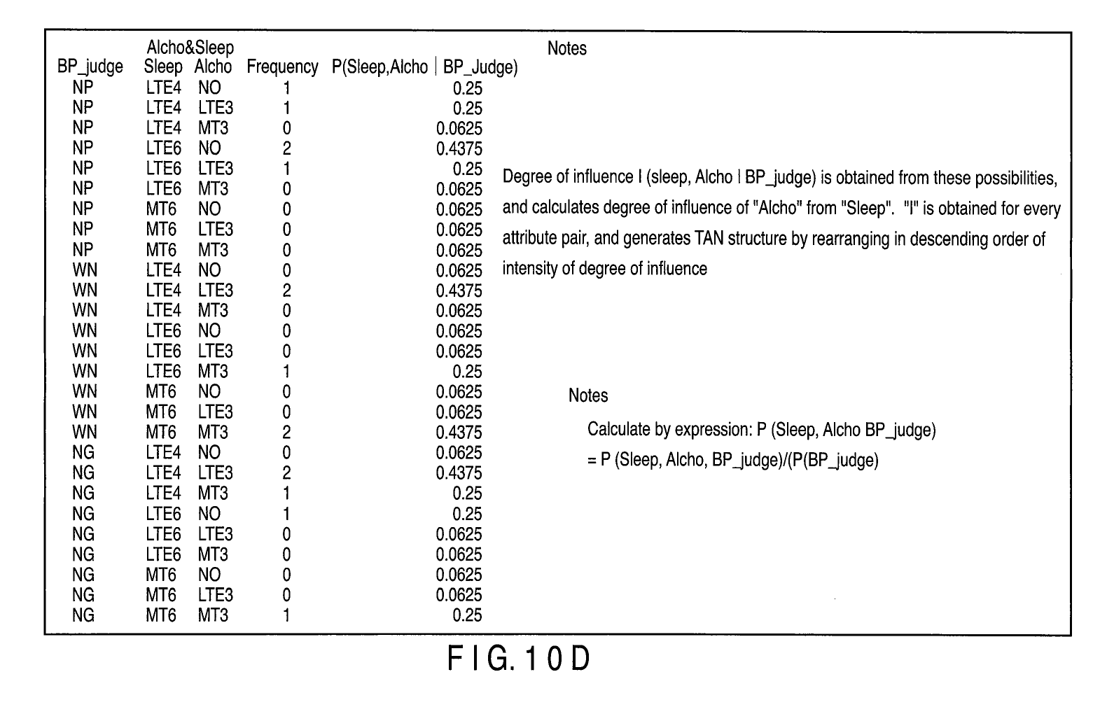

Meanwhile, a case of the method by Keogh et al. (reference document [3] described below) will be described by referring to FIGS. 11 and 12. The method Keogh et al. is a construction method of a Tree Augmented Bayesian Network (TAN) model. The method is expressed as follows:

(1) Initialize a network to naive Bayes

(2) Calculate precision of a current sorter

(3) Add a legal arc temporarily to return (2), and repeat (3) until all the available arcs are added

(4) Decide the addition of an arc if there is an arc of which the precision is improved by adding the arc

(5) Terminate processes after completing additions of arcs for all attribute nodes.

There is a report that the method by Keogh et al. is simple and is not high in precision in comparison with the method by Friedman et al. The method by Keogh et al. firstly creates a naive Bayes sorter by using all the attributes and class attributes. Here, a model configuration is expressed, for example, by the following Equation (2) and by FIG. 11.

$$P ( C \vert {A}_{1} = {V}_{1 j} \& … \& {A}_{N} = {V}_{Nj} ) , \\ {C}_{NB} = {arg max}_{C ∈ \{ {cl}_{1} , … , {cl}_{M} \}} P ( {C}_{j} ) {\prod }_{k} P ( {A}_{k} = {V}_{kj} \vert {C}_{j} ) . \qquad ( 3 )$$

Where, A is an attribute, V is an attribute value, N is the number if attributes, M is the number of classes, C is a classification class, j is an index of the M, and k is an index of the N.

The naïve Bayes is known that it may achieve a classification precision which is equivalent to other sorters although it is strongly needed to assume that all attributes are independent from one another. However, herein, for example, a possibility is assumed that “commuting time” affects on “exercise frequency”, and the method by Keogh et al calculates a probability indicating a dependence degree between attributes.

In this case, while only the classification class may become the master node for each attribute at the naïve Bayes, herein, for example, with respect to “exercise frequency”, there are two master nodes of “blood pressure judgment node” and “commuting time node” of the classification classes. In such a case, in the foregoing Equation (1) for class estimation, P (ExerFreq|commute, BP_judge) is added to a product calculation of the right side of the equation (1). Directions between two attributes affecting such an influence are tried for combinations of every attribute. In this process, the method checks classification precision in a case in which a direction having an affect on attributes is assumed, and arcs (arrow marks) between nodes of which the precision is the highest adds in turn. In FIG. 12, an arc 120 which has been added between the nodes of “commuting time” and the node of “exercise frequency” is indicated as an arc of which the precision is the highest, as an arc between the nodes of which the precision has been high. The direction of the arc (arrow mark) 120 indicates the direction having an affect on attributes. Thereby, between two attributes of “commuting time” and “exercise frequency”, two possibilities of, for example, “commuting time→exercise frequency” and “exercise frequency→commuting time” are possible approach. This means to add probabilities with each condition of P (ExerFreq|Commute, BP_judge) and P (Commute|ExerFreq, BP_judge) to the right side of the Equation (2).

The check of classification precision is performed in the following manner. The method firstly classifies the health examination data, for example, into 10 blocks, adds one arc by using data for nine blocks for model creation, then, calculates a formula of class estimation by constructing the model. Then, by using the remaining one block, the method checks the precision by calculating how high probability of the one block may predict correct blood pressure judgment.

In the embodiment, by combining the method by Friedman et al. (reference document [1] described below) with the method by Keogh et al. (reference document [3] described below), the probability classification model is constructed in the following manner.

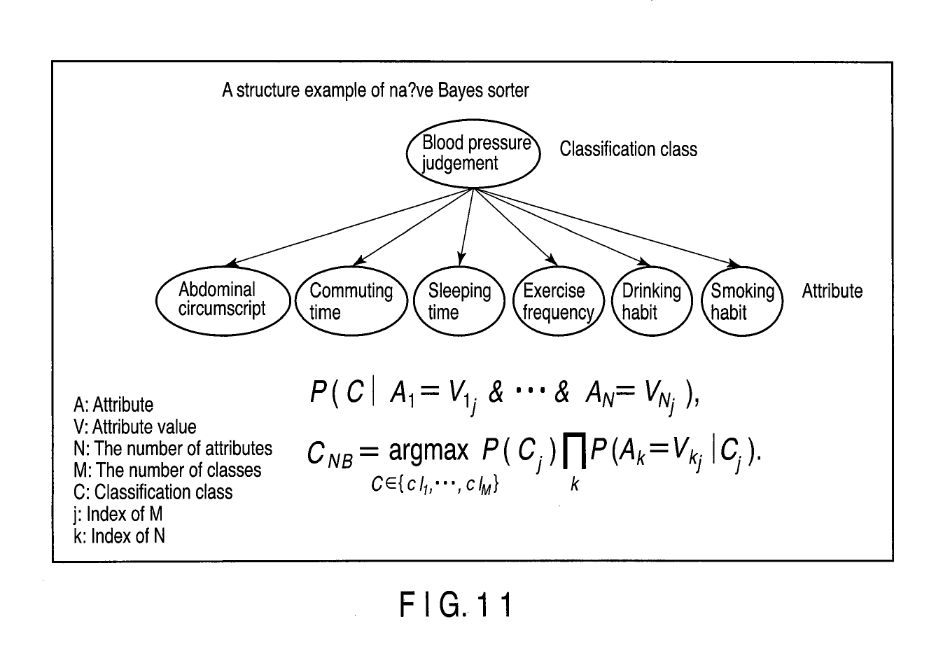

FIG. 13 shows a flowchart depicting a creation procedure of the probability classification model of the embodiment. The procedure is the same as that of the method by Keogh et al. up to Steps S1-S6 in process of creating the probability classification model.

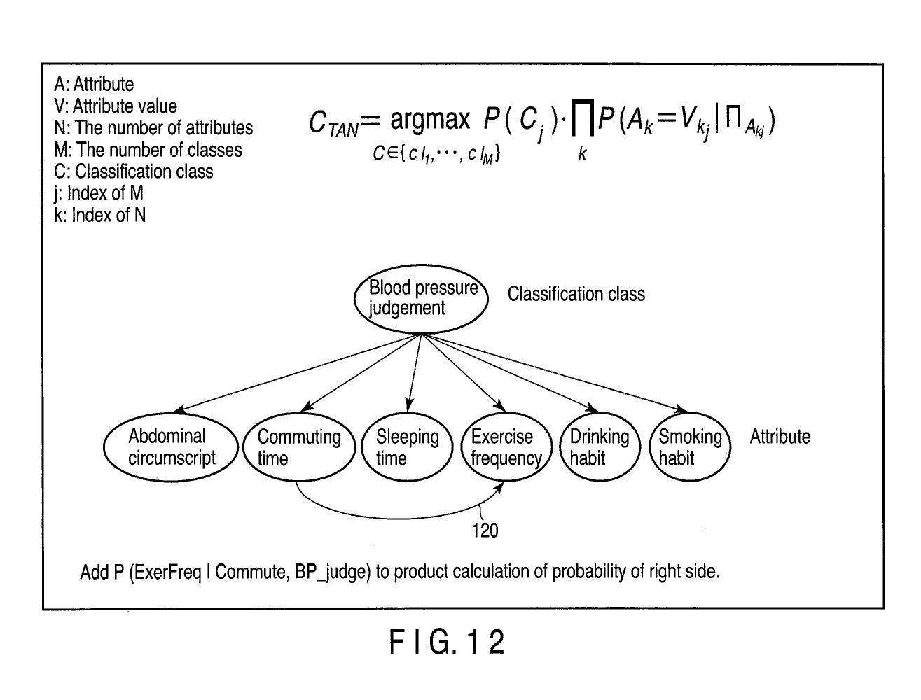

In Step S7, the device for prompting behavioral changes calculates a mutual information quantity Ip which is necessary for comparing the dependence degrees among items. For instance, if the device has been sharing the master node Z, when the item node X affects on the item node Y, calculates how much mutual information quantity is owned, rearranges the mutual information quantity among all items in descending order, and decides the directions of all arcs on the basis of comparison results. In the TAN network, as a master node of a certain node, the device restricts that only one node other than the class node can receive an input from the master node. The degree of influence Ip from the node X to the node Y in the case of existence of the master node Z is calculated in the same calculation as that of the degree of influence I (Xi, Xi|C) in the method by Friedman et al. which has been described by referring to FIGS. 9 and 10. FIG. 14 shows an example of the probability classification model created in accordance with the procedure shown in FIG. 13. In FIG. 14, an Ip1 and an Ip2 are examples of comparison of intensity of dependence relations between attributes. For instance, a selection process for deciding the master node of the “drinking habit” node will be described. In this example, two inputs are made form a candidate of the master node of the “drinking habit” node, and the degrees of an influence of the “sleeping time” node is expressed as Ip1=1.96, and of an influence of the “smoking habit” node is expressed as Ip2=0.2, respectively. Therefore, as regards this “drinking habit” node, “sleeping time” is selected as only one master node other than a class node.

While the above description has been described the learning of the probability classification model from the health examination and doctor's question result data extracted by the filtering, as regards another method for learning the probability classification model, such a Bayesian network classifier described in the reference documents [1] and [3] described below and described in FIGS. 11 and 12 may be used for the calculation, or a pure and a generic Bayesian network may be configured. In a case in which the device treats attributes which do not have many dependence relations from the first, the device may use further simple sorter configuration algorithm such as naïve Bayes described in the reference document [2] described below. Further, an arbitrary learning method which has been made in consideration of the probability dependence relations can be used.

When the probability classification model is created by the probability model generation unit 26, a plan candidate generation unit 27 tentatively changes the attribute value of each node of the classification model in a direction of an improvement, and checks a change in classification class upon performing the tentative change. The device takes out improved plans of upper N-pieces more than one as the plan candidates in order in which the probability of the classification class nodes are turned up for improvements with the least improvement.

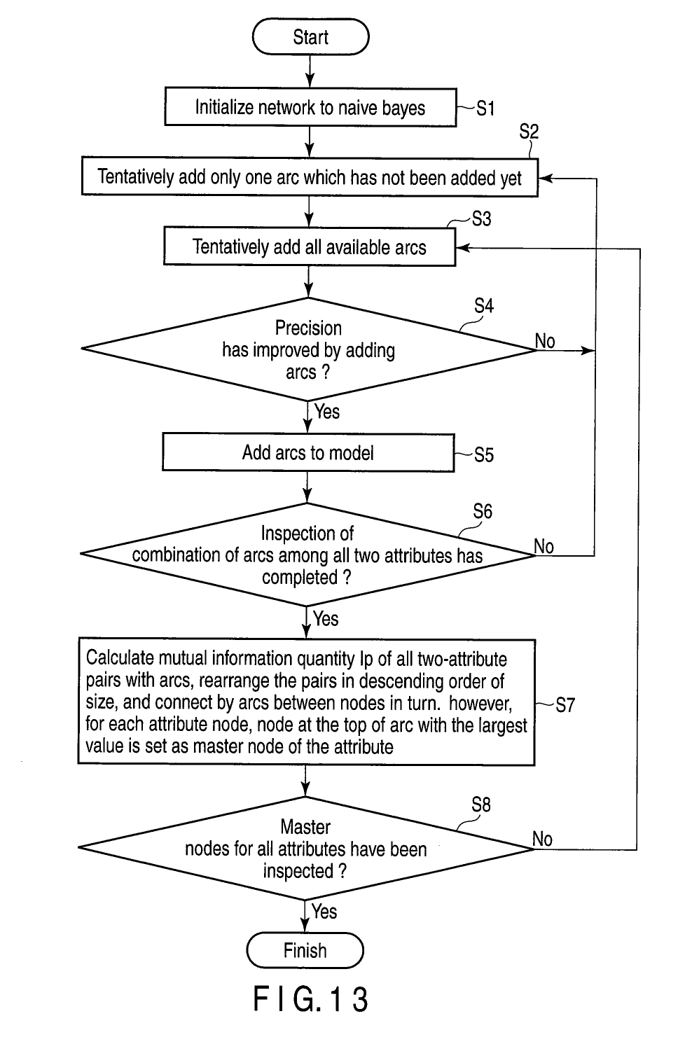

An improved plan portfolio generation unit 28 changes the attribute values at all items of the classification model in improving directions, and simulates how much probability of the classification nodes is improved. FIG. 15 shows an example of a simulation in which, for instance, setting information 29 has set as N=2. In this case, since N=2, there are two improved plans. In this case in which the improved items are described in a list form in order of easiness of improvements is referred to as “an improved plan portfolio”. The improved plan portfolio is stored in an improved plan portfolio database 30.

A first improved plan changes “sleeping time” from “less than four hours” to “six hours or more”. According to data of persons in living environments similar to those of the analysis object persons, sleeping in further two hours increases the probability of an improvement of blood pressure judgment. This increase becomes clear by means of the probability classification model shown in FIG. 15. According to the above mentioned probability calculation, the likelihood of the first improved plan has been, for example, 0.08.

Similarly, a second improved plan increases “exercise frequency” from “none” to “one or more times and less than three times a week”. According to the aforementioned probability calculation, the likelihood of the second improved plan has been, for example, 0.03. In comparison with these two likelihoods, it is clear that the first improved plan is a plan which is achieved easier than the second improved plan. In this way, the improved plan portfolio is created by arranging the improved plans in descending order in which the improved plans are easily achieved and the improving influences of “blood pressure judgment” are high.

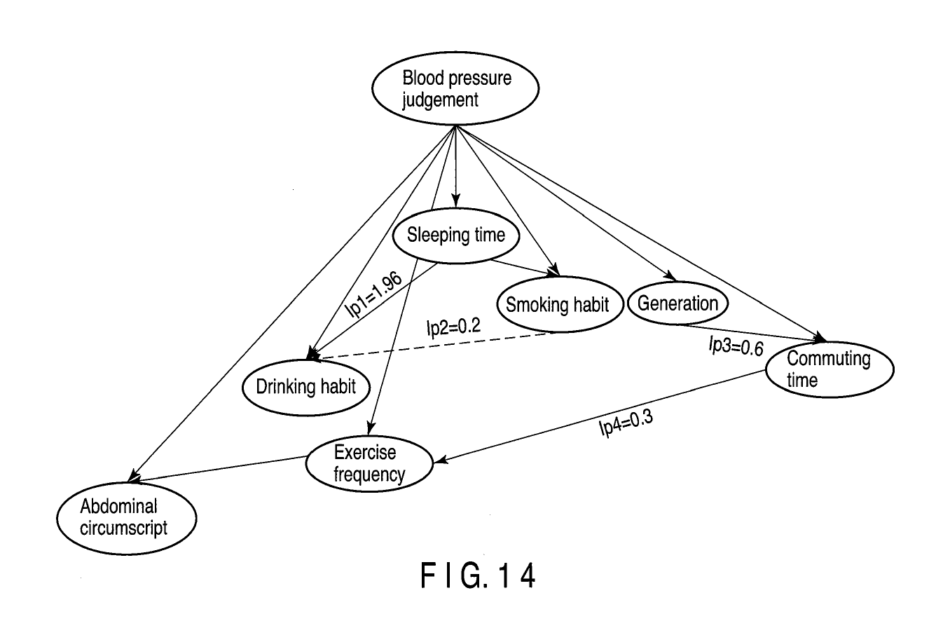

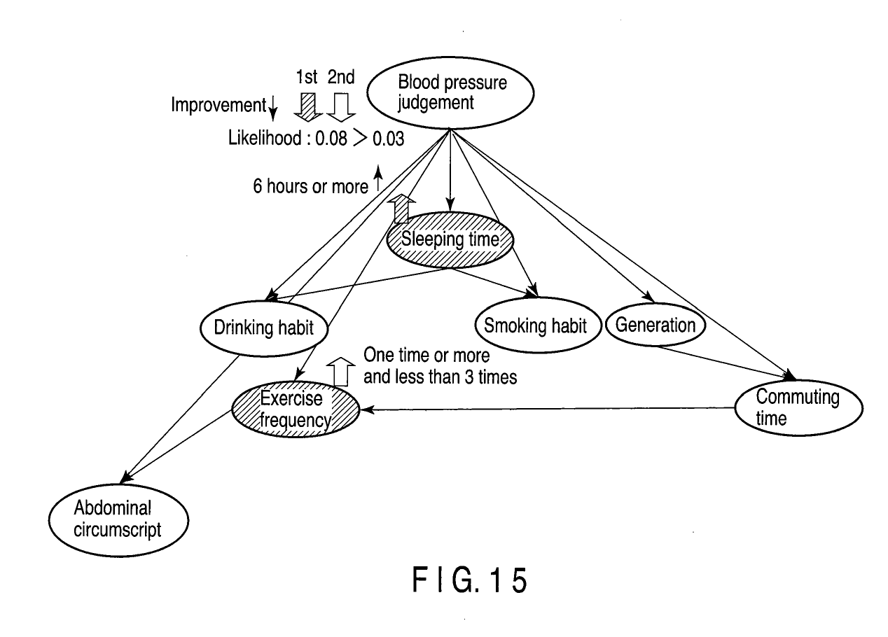

FIG. 16 shows an example of a generated improved plan portfolio. The improved plan portfolio is displayed on a result display unit 31, and a final decision is made under consent by a medical staff such as a doctor and a public health nurse, such as a case of an after-interview after a health examination and a case of obtaining consent on a network. An achievement degree input unit 32 adds the improved plan portfolio to items of an achievement degree check table 170 shown in FIG. 17.

Usually, the object person checks a check box 171 in the check table 170 so as to check through the input unit 32 whether or not each improved plan has been performed, and then, the device records the achievement degree of the improved plan portfolio. It is preferable for the recorded achievement degrees to be recognized at a glance by the object person and medical staffs by setting 80% of total days when the improved plan should be executed as object values to indicate the object lines by means of a dot line, by illustrating whether or not the object values have been achieved so as to recognize at a glance in months (or in years, or in days), and by displaying them on the display unit 31.

However, in reality, the personal preferences, restriction and background knowledge vary frequently.

For instance, in a case in which the achievement degree of the second improved plan which intents to “increase the exercise frequency up to three times in a week” becomes 30%, there is a possibility for the object person to personally think that it is impossible to “increase the exercise frequency up to three times in a week”. In this case, the device makes it possible to correct the personal preference and restriction data 40 to “ExerFreq=NO” through an improved plan portfolio correction unit 33. This correction means that the restriction that “it is impossible to increase the exercise frequency” is placed on the device. After this, the filter unit 23 filters again the data on the basis of the background knowledge, and the probability model generation unit 26 generates the probability classification model, the plan candidate generation unit 27 generates the improved plan candidate, and the improved plan portfolio generation unit generates again the improved plan portfolio. As a result, a corrected and improved plan portfolio for the behavioral change of the object person is constructed.

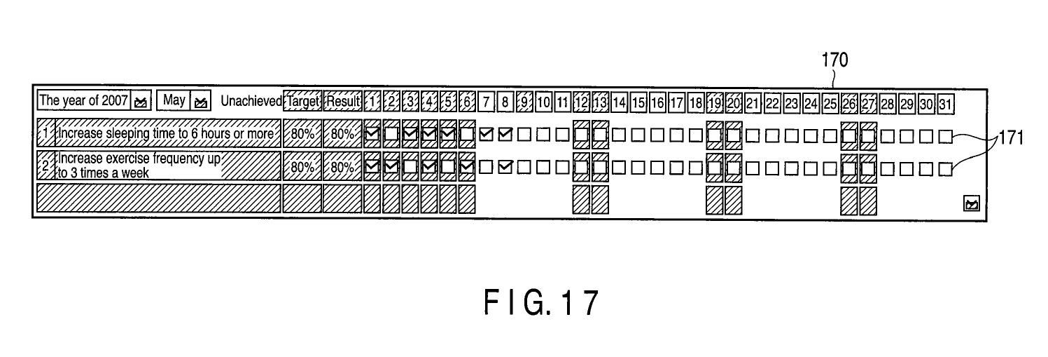

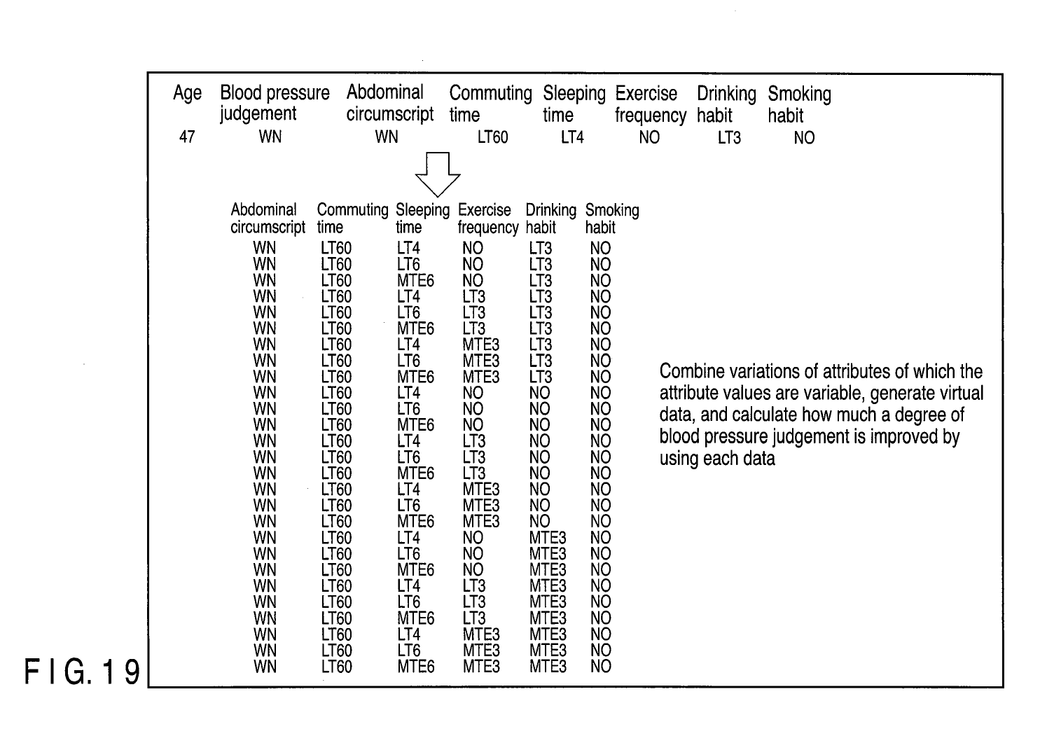

As is shown in FIG. 19, for example, it is assumed that an object person has moved and “commuting time” becomes “less than one hour (LT60)” from “one hour or more (MTE60)”. In this case, as regards possibilities, improved candidates described at a lower part of FIG. 19 are listed, and a result shown in FIG. 20 is obtained by using the listed information and by changing the preferences and restriction and by re-learning the probability classification model. As regards attributes of which the attribute values may be varied, the re-learning creates virtual data by combining the variations of the attributes and calculates how much extent “blood pressure judgment” of each data may be improved. In a process to confirm the improvement, if the setting information 29 includes the specifications of the improving directions, the device calculates the improved degree in accordance with the specifications.

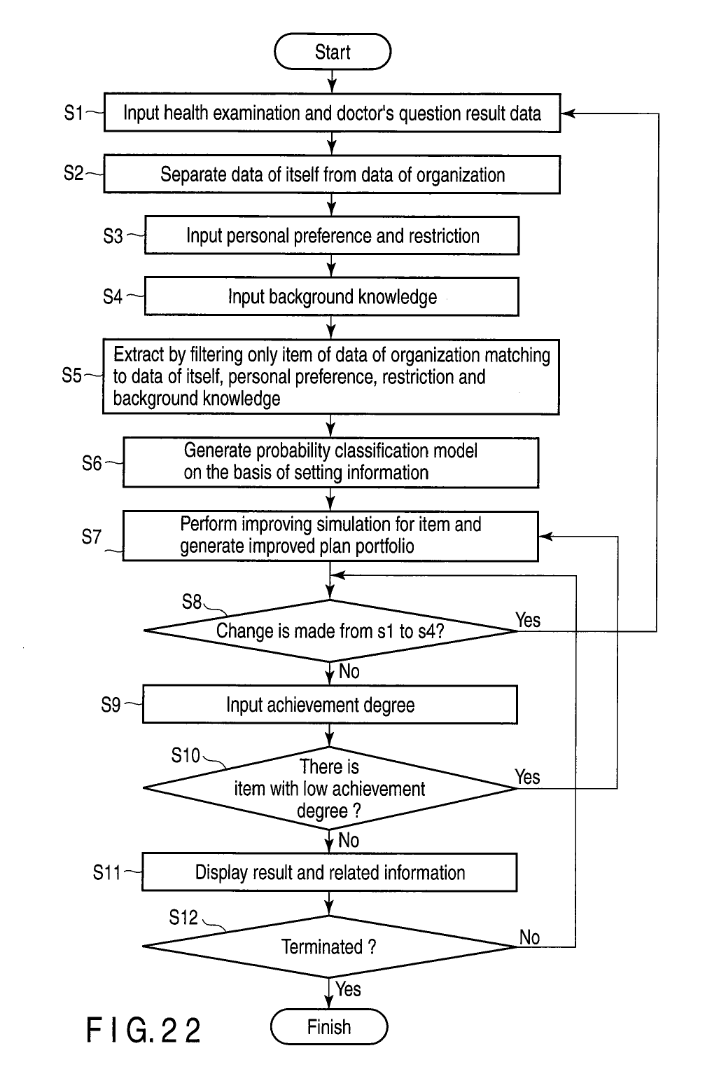

For instance, as shown in FIG. 23, the improving directions are set as “Smoke=YES→Smoke=NO” and “Smoke=NO→Smoke=No”, and the directions to improve “Smoke” are limited to these two possibilities. That is, it is specified for the condition of the blood pressure judgment to stop smoking for a smoker or not to smoke also in future for a non-smoker. Conversely, it means that “Smoke=YES→Smoke=YES” specifies non-improvement of the blood pressure judgment.

As recognized by FIG. 20, although only “commuting time” has varied, according to the change in the condition of one's own, each item and a distribution of the dependence relations has varied. More specifically, “sleeping time” affects on “drinking habit”, and the number of arrow marks 200 has increased for this time interval. With an increase in “commuting time”, the improved portfolio generation unit 28 may probabilistically increase, for example, “exercise frequency”, and may expect a result that the increase in “exercise frequency” is extremely effective on an improvement of blood pressure. Further, as a by-product, the probability “abdominal circumscript” increases from “WN” to “NP” becomes also recognized.

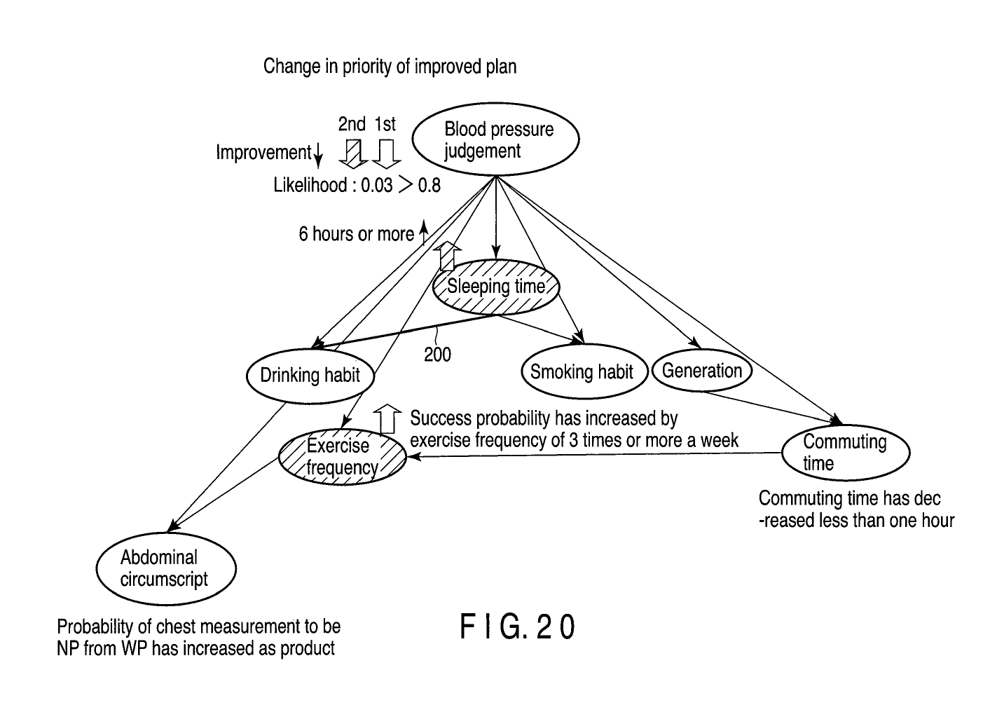

As a result, the improved portfolio is varied, for example, as is shown in FIG. 21. However, in this case, since the plan for changing “sleeping time” lowers the likelihood in comparison with the plan for changing “exercise frequency”, the device generates the improved portfolio by setting the plan for changing “exercise frequency” as the first improved plan, and by setting the plan for increasing “sleeping time” as the second improved plan. As a by-product, if there is any inspection item which is predicted to approach an improvement, it is preferable to set a related item 210 to display the fact.

The result display unit 31 displays the already exemplified health and doctor's question result data, personal preference and restriction data and learned probability classification model on terminals in response to requests from users. Especially, displaying the learned probability classification model shows suitability and ground of the automatically generated an improved plan portfolio, and enables becoming explanation of an effective ground for users who do not trust a machine, and prompts the improved behavior.

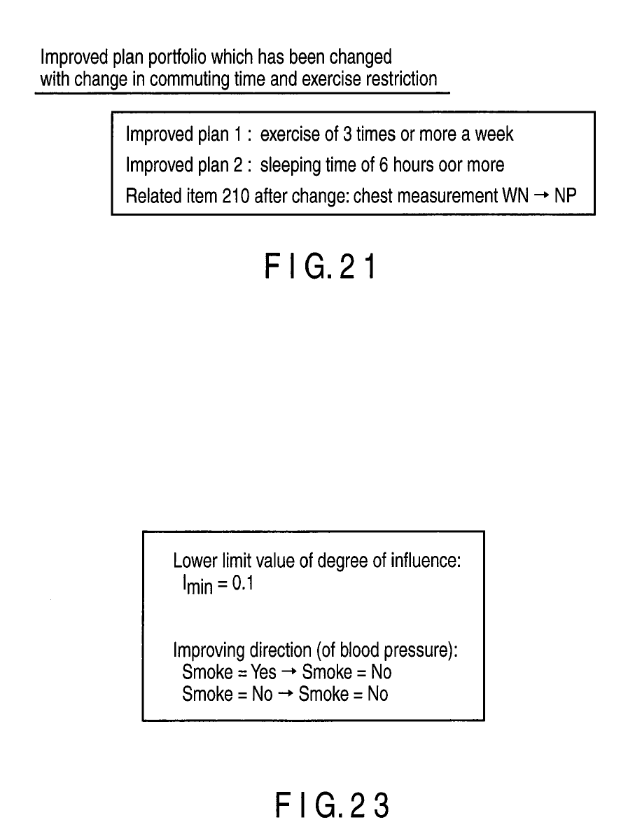

FIG. 22 shows a flowchart depicting the series of processing procedures described above. At first, in Step s1, the data input unit 20 inputs a plurality of items of health examination and doctor's result data from the database 21. In Step s2, in a set of the input health examination and doctor's question result data, the device separates the health examination and doctor's question result data of a specified individual (e.g., himself or herself) from the health examination and doctor's question result data of an organization other than the data of the specified individual. The personal preference and restriction input unit 22 inputs the data 40 of the specified individual in Step s3. The background knowledge 24 is input in Step s4. In Step s5, the filtering processing by means of the filter unit 23 extracts the health examination and doctor's question result data which matches to the health examination and doctor's question result data of the specified individual, the data 40 input in Step s3, and the background knowledge 24 input in Step s4.

The probability model generation unit 26 generates the probability classification model on the basis of the setting information 29 in Step s6. The setting information 29 includes a lower limit value Iₘᵢₙ of the degree of influence to be used whether or not an arrow mark indicating the dependence relations from a certain node to another node should be added, for example, upon generating the probability classification model (FIG. 23). For instance, if Ip is equivalent to 0.05, in this example, since Iₘᵢₙ=0.1, the degree of influence is so lower than the lower limit Iₘᵢₙ that it is shown that the dependence relations may not be introduced between the nodes.

The plan candidate generation unit 27 performs an improvement simulation of items to generate the improved plan portfolio in Step s7. In Step s8, it is determined whether or not any change (e.g., change in personal preference and restriction) in the data input in Steps s1-s4 has occurred. For instance, in a case in which the user and so on corrects the personal preference and restriction data 40 by means of the improved plan portfolio correction unit 33, the flowchart returns to Step s1 and generates “an improved plan portfolio after correction”. If the data input in Steps s1-s4, has not varied, input processing of the achievement degree for the improved plan portfolio is conducted in Step s9. The user etc. may input the achievement degree thorough the achievement degree input unit 32.

It is determined whether or not there is any item of which the achievement degree is low in Step s10. In such a case, the flowchart returns to Step s7, the device executes again the improving simulation for the items. If there is no item of which the achievement degree is low, the result display unit 31 displays the achievement results and related items of the improved plan in Step s12. In a case of continuation of processing, the device returns to Step s8 and prepares so as to respond, at every time, to the change in the data input in Steps s1-s4.

### Other Embodiments

Another embodiment has a feature which uses a medical history (previous diseases) data in relation to the personal preferences and restriction. The health examination and doctor's question result database 21 inputs the medical history (previous diseases) data in the personal preference and restriction input unit 22. For instance, if there is the medical history of “there is a case of acute hepatitis”, the back ground 24, which always includes an item related to drinking (e.g., “do not drink, or [cannot drink]”) as a restriction item, is prepared in advance. In this case, improving items may be narrowed for the purpose of performing health management so as to especially think a great deal of a liver. When the improved plan portfolio generation unit 28 creates the improved plan portfolio, the embodiment has an advantage over items related to drinking in that it may know in advance the impossibility of an increase in the number of times of the drinking habits.

As regards the personal preferences and restriction, it is preferable to use the medical history (previous diseases) data not only of the user himself or herself but also its family and relatives. In this case, the input unit 22 inputs the medical history (previous diseases) data not only of the user himself or herself but also its family and relatives all together. For instance, if there is the medical history of “there is a case of acute hepatitis”, the back ground 24, which always includes an item related to drinking (e.g., “do not drink [cannot drink]”) as the restriction item, is prepared in advance. Also in this case, for the purpose of performing the health management so as to especially think a great deal of liver. When the improved plan portfolio generation unit 28 creates the improved plan portfolio, the embodiment has an advantage over items related to the drinking in that it may know in advance the impossibility of the increase in the number of times of the drinking habits.

Further, as another embodiment, it is preferable to apply encryption processing to a various pieces of data to be processed by the data input unit 20 and the personal preference and restriction input unit 22. More specifically, it is preferable to encrypt items such as an ID which can specify an individual so that any individual cannot be specified. Thereby, at a view point of personal information protection, the device for prompting behavioral changes makes it possible not to carelessly know to whom the data belongs from another data.

According to the above embodiments, the device for prompting behavioral changes may provide the improved behavior portfolio to the object person while taking the personal preferences and restriction varying hour to hour into account. The device may flexibly change the improved plan for the behavioral changes in response to the achievement degree; thereby the object person may intend to improve health condition by continuous behavioral changes without loosing motivation.

### REFERENCE DOCUMENTS

Hereinafter, a list of reference documents will be shown.
[1] N. Friedman, D. Geiger, and M. Goldszmidt. Bayesian Network Classifiers, Machine Learning 29, pp. 131-163, 1997.
[2] G. I. Webb, J. Boughton, and Z, Wang. Not So Naive Bayes: Aggregating One-Dependence Estimators. Machine Learning 58(1), pp. 5-24, 2005.
[3] Keogh, E. & Pazzani, M. (1999). Learning augmented Bayesian classifiers: A comparison of distribution-based and classification-based approaches. In Uncertainty 99, 7th. Int'l Workshop on AI and Statistics, Ft. Lauderdale, Fla., pp. 225-230.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A device for prompting behavioral changes, comprising:
a data input unit which inputs first health examination and doctor's question result data with respect to an individual being an object person, and second health examination and doctor's question result data with respect to a plurality of persons other than the object person, the first and second health examination and doctor's question result data including items having attribute values;
a personal preference and restriction input unit which inputs personal preference and restriction data showing personal preferences and restriction of the individual being an object person;
a filter unit which applies filtering as regards the first and second health examination and doctor's question result data which are input from the data input unit so as to fulfill the personal preference and restriction data obtained from the personal preference and restriction input unit, and remains only health examination and doctor's question result data of persons with the same or close conditions of the object person;
a probability model generation unit which uses the health examination and doctor's question result data filtered by the filter unit and generates a probability classification model in consideration of probability dependence relations among nodes equivalent to items of the health examination and doctor's question result data, the model including a classification class node;
a plan candidate generation unit which tentatively changes at least one of the attribute values of nodes of the probability classification model in an improving direction, checks changes in the classification class node upon performing the tentative changes, and generates high-raking N-pieces of improved plans, as plan candidates, in descending order of improvements of probabilities of the classification class nodes through the least improvement;
an improved plan portfolio generation unit which generates an improved plan portfolio by listing the plan candidates in descending order of easiness of improvements;
an improved plan portfolio change unit which executes again at least any one of the filtering, the generation of the probability classification model, the generation of the plan candidates and the generation of the improved plan portfolio in response to changes in the first and second health examination and doctor's question result data or the personal preference and restriction data, and generates an improved plan portfolio after changing; and
a result display unit which displays the improved plan portfolio after changing.

2. The device according to claim 1, wherein the personal preference and restriction data includes medical history data of the individual of being the object person.

3. The device according to claim 1, wherein the personal preference and restriction data includes medical history data of the individual of being the object person and medical history data of relatives of the object person.

4. The device according to claim 1, wherein the first and second health examination and doctor's question result data, and the personal preference and restriction data are encrypted with regard to items in the data which specify the individual.

5. The device according to claim 1, wherein the probability model generation unit calculates degrees of influences showing probability dependence relations among the nodes on the basis of a probability with conditions.

6. A method for prompting behavioral changes, comprising:
inputting first health examination and doctor's question result data with respect to an individual being an object person, and second health examination and doctor's question result data with respect to a plurality of persons other than the object person, the first and second health examination and doctor's question result data including items having attribute values;
inputting personal preference and restriction data showing personal preferences and restriction of the individual being the object person;
filtering as regards the first and second health examination and doctor's question result data so as to fulfill the personal preference and restriction data, and remains only health examination and doctor's question result data of persons with the same or close condition of the object person;
using the filtered health examination and doctor's question result data, and generating a probability classification model in consideration probability dependence relations among nodes equivalent to items of the health examination and doctor's question result data, the model including a classification class node;
tentatively changing at least one of the attribute values of the nodes of the probability classification model in an improving direction, checking changes in the classification class node upon tentatively changing, and generating high-raking N-pieces of improved plans, as plan candidates, in descending order of improvements of probabilities of the classification class nodes from the least improvement;
generating an improved plan portfolio by listing the plan candidates in descending order of easiness of improvements;
executing again at least any of the filtering, generation of the probability classification model, generation of the plan candidates and generation of the improved plan portfolio in response to changes in the first and second health examination and doctor's question result data or the personal preference and restriction data, and generating an improved plan portfolio after changing; and
displaying an improved plan portfolio after changing.

7. The method according to claim 6, wherein the personal preference and restriction data includes medical history data of the individual of being the object person.

8. The method according to claim 6, wherein the personal preference and restriction data includes medical history data of the individual of being the object person and medical history data of relatives of the object person.

9. The method according to claim 6, wherein the first and second health examination and doctor's question result data, and the personal preference and restriction data are encrypted with respect to items in the data which specify the individual.

10. The method according to claim 6, wherein the generating the probability model includes calculating degrees of influences showing probability dependence relations among the nodes on the basis of a probability with conditions.

11. A computer readable storage medium storing instructions of a computer program which when executed by a computer results in performance of steps comprising:
inputting first health examination and doctor's question result data with respect to an individual being an object person, and second health examination and doctor's question result data with respect to a plurality of persons other than the object person, the first and second health examination and doctor's question result data including items having attribute values;
inputting personal preference and restriction data showing personal preferences and restriction of the individual being the object person;
filtering as regards the first and second health examination and doctor's question result data so as to fulfill the personal preference and restriction data, and remains only health examination and doctor's question result data of persons with the same or close condition of the object person;
using the filtered health examination and doctor's question result data, and generating a probability classification model in consideration probability dependence relations among nodes equivalent to items of the health examination and doctor's question result data, the model including a classification class node;
tentatively changing at least one of the attribute values of the nodes of the probability classification model in an improving direction, checking changes in the classification class node upon tentatively changing, and generating high-raking N-pieces of improved plans, as plan candidates, in descending order of improvements of probabilities of the classification class nodes from the least improvement;
generating an improved plan portfolio by listing the plan candidates in descending order of easiness of improvements;
executing again at least any of the filtering, generation of the probability classification model, generation of the plan candidates and generation of the improved plan portfolio in response to changes in the first and second health examination and doctor's question result data or the personal preference and restriction data, and generating an improved plan portfolio after changing; and
displaying an improved plan portfolio after changing.

12. The program according to claim 11, wherein the personal preference and restriction data includes medical history data of the individual of being the object person.

13. The program according to claim 11, wherein the personal preference and restriction data includes medical history data of the individual of being the object person and medical history data of relatives of the object person.

14. The program according to claim 11, wherein the first and second health examination and doctor's question result data, and the personal preference and restriction data are encrypted with respect to items in the data which specify the individual.

15. The program according to claim 11, wherein the degrees of influences showing probability dependence relations among the nodes are calculated on the basis of a probability with conditions.
